(19) United States
(12) Patent Application Publication
(10) Pub. No.: US 2010/0131688 A1
(43) Pub. Date: May 27, 2010

(54) INTERFACE METHOD FOR DATA TX/RX SYSTEM USING DATA STREAM

(75) Inventors: Dong-hoon BAEK, Seoul (KR); Ji-hoon KIM, Seoul (KR); Jung-pil LIM, Seoul (KR); Jae-youl LEE, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 12/614,549

(22) Filed: Nov. 9, 2009

(30) Foreign Application Priority Data
Nov. 26, 2008 (KR) 10-2008-0118352

(51) Int. Cl. G06F 13/42; G06F 9/00

(52) U.S. Cl. 710/106; 713/2

(57) ABSTRACT

An interface method for a data transmitting and receiving system including a transmitter and a receiver includes; resetting the receiver in response to a data stream communicated from the transmitter or upon detecting power-up of the transmitter or receiver, and operating the receiver in response to a current data stream received from the transmitter, wherein the operating of the receiver comprises at least one of; (a) updating data stored in the receiver according to control data contained in the current data stream, and (b) receiving payload data contained in the current data stream.

### CROSS-REFERENCE TO RELATED APPLICATION

This application claims the benefit of Korean Patent Application No. 10-2008-0118352 filed on Nov. 26, 2008, the subject matter of which is hereby incorporated by reference.

### BACKGROUND

The inventive concept relates to an interface method for a data transmission (TX) and receive (RX) system. More particularly, the inventive concept relates to an interface method for a data TX/RX system communicating a data stream using a point to point transmission approach.

Liquid crystal displays (LCDs) may be driven in various manners according to the resolution and panel size thereof. Conventionally, when data is transmitted and received using reduced swing differential signaling (RSDS) and mini low voltage differential signaling (LVDS), a multi-drop architecture is used. A multi-drop architecture is typically characterized by the use of at least one timing controller and a plurality of source drivers sharing a bus. In a multi-drop architecture, data is transmitted using a time-sharing scheme via the shared bus. Thus, a great deal of time is consumed during the transmission and reception of data.

As the size of display panels, including LCD panels, has increased, various attempts have been made to improve the reproduction quality of displayed images. Many of these attempts involve increasing the data transmission rate of constituent data. To this end, point to point data transmission methods have been proposed to facilitate the high speed transmission and reception of data in systems incorporating a display panel. In a point to point data transmission method, data is directly transmitted from one transmitter to multiple receivers rather than using multiple drops from a shared bus. In a typical data TX/RX system, a transmitter should check whether a receiver is ready to receive data before actually transmitting the data (i.e., send a status request), and a receiver should be able to effectively communicate its status to a requesting transmitter (i.e., return a status response).

In order to directly receive data from a transmitter, a receiver must initialize certain circuits at the moment when power is initially supplied (i.e., upon “power-up”). To improve data transmission and reception speed, a receiver should, under defined conditions, also be able to initialize certain circuits even as data is communicated from a transmitter. A transmitter should similarly be able to efficiently initialize certain circuits as data transmission begins.

### SUMMARY

Embodiments of the inventive concept provide an interface method for a data TX/RX system, wherein a receiver may optimally receive data communicated from a transmitter using a point to point method.

According to an aspect of the inventive concept, there is provided an interface method for a data transmitting and receiving system comprising a transmitter and a receiver, the method comprising; resetting the receiver in response to a data stream communicated from the transmitter or upon detecting power-up of the transmitter or receiver, and operating the receiver in response to a current data stream received from the transmitter, wherein the operating of the receiver comprises at least one of; (a) updating data stored in the receiver according to control data contained in the current data stream, and (b) receiving payload data contained in the current data stream.

According to another aspect of the inventive concept, there is provided an interface method for a data transmitting and receiving system comprising a timing controller and a source driver driving display data to a panel display, the method comprising; operating in a reset mode during which a value stored in a register of the source driver is initialized in response to (a) an indication that the timing controller is communicating a current data stream, and (b) a power-up detection for the source driver or the timing controller, and operating in a receive ready mode during which the source driver prepares to receive payload data contained in the current data stream.

According to another aspect of the inventive concept, there is provided an interface method for a data transmitting and receiving system comprising a timing controller and a source driver driving display data to a panel display, the method comprising; operating in a reset mode during which a value stored in a register of the source driver is initialized in response to a current data stream communicated from the timing controller to the source driver, or in response to a power-up detection for the source driver or to the timing controller, operating in a setup mode during which control data contained in the current data stream initializes a value stored in the register of the source driver, and operating in a receive ready mode during which the source driver prepares to receive the display data contained in the current data stream. The data stream also contains; a data stream transfer start indication indicating a beginning of a transfer of the current data stream from the timing controller to the source driver, register control data configured to update the value stored in the register of the source driver, data defining a wait period during which the display data is processed by the source driver, a data stream transfer end indication indicating an ending of a transfer of the current data stream from the timing controller to the source driver, and data defining a standby period prior to receipt of a next data stream.

### BRIEF DESCRIPTION OF THE DRAWINGS

Embodiments of the inventive concept will be more clearly understood from the following detailed description taken in conjunction with the accompanying drawings in which:

FIG. 1 is a state diagram illustrating an embodiment of an interface method for a data TX/RX system according to an embodiment of the inventive concept;

FIG. 2 is a state diagram illustrating an embodiment of an interface method for a data TX/RX system according to another embodiment of the inventive concept;

FIG. 3 illustrates an exemplary data stream that may be used in an interface method for a TX/RX system according to another embodiment of the inventive concept;

FIG. 4 illustrates an exemplary execution sequence for an interface method for a TX/RX system according to another embodiment of the inventive concept;

FIG. 5 is a waveform diagram illustrating signals related to a data stream transfer start identifying operation;

FIG. 6 is a waveform diagram of signals related to a data stream transfer end identifying operation;

FIG. 7 is a flowchart summarizing one interface method for a data TX/RX system according to another embodiment of the inventive concept;

FIG. 8 is a flowchart summarizing another interface method for a data TX/RX system according to another embodiment of the inventive concept; and

FIG. 9 is a block diagram of a liquid crystal display (LCD) employing a point to point data communication method according to an embodiment of the inventive concept.

### DETAILED DESCRIPTION OF THE EMBODIMENTS

Hereinafter, certain embodiments of the inventive concept will be described in some additional detail with reference to the accompanying drawings. Throughout the drawings and written description, like reference numbers and labels are used to denote like elements and features.

Certain embodiment of the inventive concept will be described in the context of a liquid crystal display (LCD) apparatus, which is presented as an example of a broader class of data TX/RX systems. That is, the LCD panel comprises a source driver supplying display data to the display elements within the display panel, and a timing controller communicating a data stream from which the display data is derived, as well as control data applied to the source driver. In the illustrated example, the timing controller may be considered an exemplary transmitter, and the source driver and/or the display panel may be considered as receivers.

A “data stream” is defined as a body of data containing both payload data and control data. In the context of a LCD display panel, payload data is the display data communicated (e.g.) to the source driver (i.e., the data defining the image to-be-displayed on the panel). In contrast, the control data is data controlling the operation of the source driver (and/or related display circuits). When a data stream includes control data corresponding to one horizontal line of a display panel, and the display data within the data stream may be referred to as line data. Accordingly, even though a data stream typically contains many segments of line data, the terms “line data” and “data stream” may be used interchangeably to indicate a stream of data containing both control data and display data.

Figure (FIG.) 1 is a state diagram illustrating an embodiment of an interface method for a data TX/RX system according to an embodiment of the inventive concept. Referring to FIG. 1, an interface method 100 comprises a reset mode (RESET), a setup mode (SETUP), and a receive ready mode (Rx READY).

The reset mode is “entered” (i.e., certain operations associated with the reset mode are executed) upon power-up (i.e., when power is first applied to a timing controller—a transmitter, or a source driver—a receiver). In the reset mode, values stored in a source driver register are initialized.

The reset mode (RESET) may also be entered when the timing controller identifies certain TX/RX system conditions (i.e., a TP violation). Thus a timing controller may communicate a RESET command forcing entry into the reset mode by means of a control data contained in a data stream transmitted from the timing controller to the source driver. For example, a timing controller may send a RESET command upon noting a TP violation when a data stream transfer end identifying period (or “end of line”, or (EOL)) is not included between two data stream transfer start identifying periods (or “start of line”, or (SOL)). Under these conditions, a return to reset mode is required since a necessary data stream EOL is missing and one data stream can not be identified from the next without the missing EOL indication.

In the setup mode (SETUP), certain source driver register values may be updated in response to a register control signal included within a data stream. That is, when a RESET command is not included in a data stream sent from a transmitter (i.e., a “TP valid” condition exists) and a packet identity data (PID) contained in the data stream properly identifies a first data state for the source controller, (i.e., a “PID=H” condition exists), then the setup mode is entered and the source driver register values may be modified.

The receive ready (Rx READY) mode may be entered from the setup mode or the reset mode. Transition of the PID from a first state (PID=H) to a second state (PID=L) while the TX/RX system is in the setup mode will cause a transition from the setup mode to the receive ready mode—that is, when a current data stream contains a PID indicating that the TX/RX system should enter the receive ready mode following the setup mode.

In the receive ready mode (really a receive ready state), a source driver may initialize circuits in preparation for receipt of a data stream. However, if the PID of a current data stream indicates an entry into the receive ready mode while the TX/RX system is operating in any mode other than the reset mode (e.g., the reset mode), a TP violation results. While the TX/RX system is in the receive ready mode and so long as the PID indicates the receive ready mode (PID=L), the TX/RX system remains in the receive ready mode (! TP violation && PID=L). However, the PID of a current data stream may indicate a state transition from the receive ready mode to the setup mode (i.e., PID goes from L to H), or a transition from the receive ready mode to the reset mode (i.e., a TP violation).

Hence, the PID is not only used to indicate entry into the setup mode, but also entry into the receive ready mode. In the foregoing example, a single data bit has been assumed as a PID (e.g., a high logic state “H” for the setup mode and a low logic state “L’ for the receive ready mode), but this is merely a simple example of more complicated PIDs potentially containing much more control data. However, in certain embodiments of the inventive concept and in order to more securely distinguish between a command to enter the setup mode and a command to enter the receive ready mode, a multi-bit (i.e., 2 or more) PID may be used.

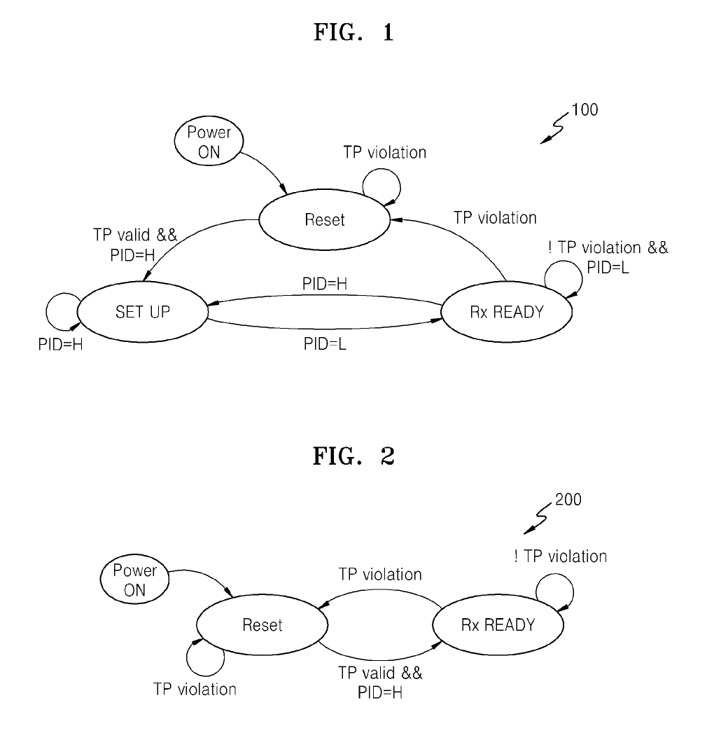

FIG. 2 is a state diagram illustrating an embodiment of an interface method for a data TX/RX system according to another embodiment of the inventive concept.

An interface method 200 illustrated in FIG. 2 comprises a reset mode (RESET) and a receive ready mode (Rx READY), but not a setup mode as described in the interface method of FIG. 1. As illustrated in FIG. 2, a data Tx/Rx system according to an embodiment of the inventive concept may operate normally without mandating a conditional entry into a corresponding setup mode. In such embodiments, source driver register values must be updated, as needed, during time periods in which a data stream is being received, i.e., after the receive ready mode is complete.

Using a conventional multi-drop method, a data stream is transmitted to a plurality of source drivers connected via a shared bus by a timing controller using a time-sharing scheme. Thus, an output terminal of the timing controller connected to a signal line of the shared bus is commonly connected to each one of the plurality of source drivers. Accordingly, the data communication interfaces between the timing controller and each one of the plurality of source drivers will be the same (i.e., must operate according to the same conditions).

In contrast, using a point to point method, a plurality of source drivers connected to a common timing controller respectively transmit and receive data via different output terminals of the timing controller. Thus, data communication interfaces between the timing controller and the source drivers may be different (i.e., operate according to different conditions). However, many legacy Tx/Rx systems are configured to operate according to the foregoing state relationships described in conjunction with FIGS. 1 and 2. These operating state definitions must be honored by any emerging Tx/Rx system to preserve backward system compatibility. Hence, the problem arises of how to incorporate the benefits afforded by a point to point data communication method within Tx/Rx systems designed according to operating modes assuming a conventional multi-drop data communication method.

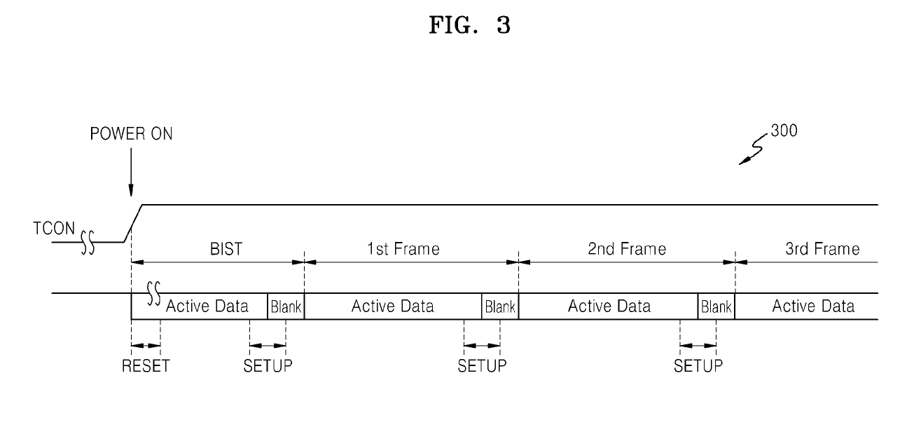

FIG. 3 illustrates an exemplary data stream that may be operated upon by an interface method for a data Tx/Rx system according to an embodiment of the inventive concept. Referring to FIG. 3, a built in self test (BIST) is performed upon power-up as indicated by a control signal transition (TCON Power ON) provided to a timing controller or source driver. Following the built in self test period, a first frame, a second frame, and so on, are sequentially communicated to the source driver. In general, the length of a BIST period is several times longer than the period during which the first and second frames are communicated.

Referring to FIG. 3, immediately upon receiving a power-up indication, a reset mode is entered at the beginning of the built in self test period. A setup mode is entered near the end of the built in self test period. Following entry into the initial setup mode, frame data is sequentially received during a receive ready mode. That is, the 1^{st} through Nth frame periods generally occur during a receive ready mode.

Each frame period allows the reception of a defined quantity of display data (i.e., line data) that will ultimately be reproduced on a display panel. In certain embodiments of the inventive concept, the timing controller transmits line data bundled in units of horizontal lines for use by the display panel. Thus, the timing controller communicates line data as one or more line data segments per each frame period.

Display data communication errors may be reduced within this sequence of data packets by entering a setup mode before each frame period (i.e., executing certain setup mode operations as (or after) a current data stream is being process and before receiving a “next data stream”).

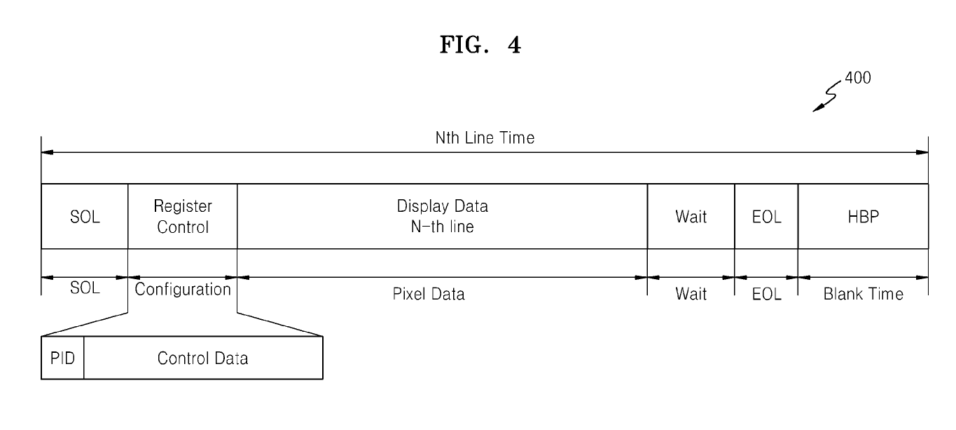

FIG. 4 illustrates a data communication interface method for a data Tx/Rx system according to another embodiment of the inventive concept. Referring to FIG. 4, in order to transmit one line data segment, used here as an example of a current data stream, the following six operations are performed:

1. A data stream transfer start indication (e.g., a start of line or SOL) should be provided. This indication may be used to determine that a timing controller has begun communication of a current data stream to a source driver.

2. A register update indication may then be provided. This indication allows (e.g.) certain source driver register values to be updated in relation to configuration data (e.g., register control data) provided within the control data of the current data stream.

3. Communication of the display data should follow during which the source driver receives one or more line data segments provided by the current data stream.

4. A WAIT period follows during which the communicated display data is processed by the source driver.

5. A data stream transfer end indication (e.g., an end of line or EOL) should be provided. This indication may be used to determine that a timing controller has ended communication of the current data stream to a source driver.

6. Finally, a standby period (HBP) follows before a next data stream is received.

In order to enter the reset modes described in relation to FIGS. 1 and 2, a data stream transfer end indication (EOL) may be replaced by a data stream transfer start indication (SOL) within the foregoing sequence of steps. Under normal operating conditions, the foregoing six steps are sequentially executed in relation to control data and/or payload data contained in a current data stream, and this sequence is altered only for abnormal operating conditions.

Thus, according to certain embodiments of the inventive concept, after a reset mode is entered (e.g., in response to a power-up indication or TP violation), a current data stream communication includes (1) provision and receipt of a transfer start indication (SOL1), (2) register update, as needed, (3) communication of display data, (4) waiting during display data processing, (5) provision and reception of (another) transfer start indication (SOL2), followed by (6) a standby period. This sequence of steps intentionally causes an abnormal operating condition, as if two consecutive data streams have been communicated without a separating transfer end indication (EOL). When this abnormal operating condition is detected, the source driver forces entry into the reset mode. Thus, the intentionally substituted second data stream transfer start indication (SOL2) acts as a data stream transfer end indication (EOL), since data stream processing is interrupted by entry into the reset mode.

In order to more exactly distinctly force entry into the reset mode, four or more sequentially communicated data stream transfer start indications (SOLs) may be communicated during the transfer of two line data segments.

In the foregoing sequence of steps, register update (e.g., a register control operation) will be performed in accordance with the presence of certain control data (e.g., configuration data) within the current data stream. In certain embodiments of the inventive concept, such configuration data may include the packet identity data (PID). For example, a constituent PID value (PID=H) may indicate that a source driver register update is mandated using provided control data. Thus, a command indication to update a register may be identical to a command to enter the setup mode. Under the foregoing assumptions, the receive ready mode may be entered using a different PID value (e.g., PID=L). Note that the source driver can receive the PID only in the receive ready mode.

When a register is updated with each line data segment transfer, the current data stream may be transmitted more completely and with reduced potential for errors. A determination to update register values with each transfer of a line data segment may be accomplished according to the approach illustrated in FIG. 4 or according to the approach illustrated in FIG. 3 (i.e., near the end of each frame period), for example.

The display data communicated after a register update is payload data to be displayed on the display panel in the working examples described above. In certain embodiments of the inventive concept, each data stream corresponds to an N-th horizontal line segment for the display panel, where N is a positive integer.

The WAIT period associated with display data processing may be variously defined according to the operating characteristics of the receiver (e.g., the source driver). That is, the display data processing operation (WAIT) corresponds to a reserved period of time necessary to store the display data received by the source driver in a data latch block of the source driver.

The data stream transfer end indication (EOL) corresponds to a time at which the display data stored in the data latch block of the source driver starts to be converted into an analog voltage signal and charge sharing occurs.

The standby operation (HBP) corresponds to a period of time during which a horizontal display line segment of the display panel corresponding to the converted analog voltage signal is driven in response to the converted analog voltage signal. That is, the standby operation (HBP) corresponds to a period of time before the line data having display information regarding a next horizontal line is received, and is thus referred to as a horizontal blank period (HBP). On the other hand, blank sections included at the ends of the built in self test period and each one of the frame periods may be included in a last horizontal line data. Accordingly, the blank sections are time periods between when a last horizontal line data for a previous data stream is transmitted and when data for a current data stream is received. Thus, such periods are referred to as vertical blank sections.

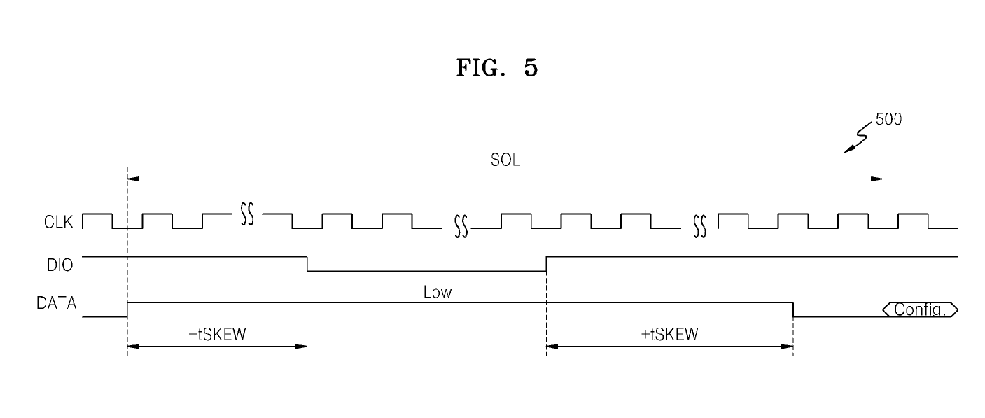

FIG. 5 is a waveform diagram for signals related to a data stream transfer start indication (SOL). Referring to FIG. 5, whether the data stream transfer start indication (SOL) starts is determined by a data input/output control signal (DIO), a data signal (DATA) which are received from a timing controller, and configuration data included in a data stream. It is determined that the data stream transfer start indication (SOL) starts when a data signal is high and the data input/output control signal is low, and when first configuration data (Config) is detected while the data signal DATA is still low. A clock signal CLK is commonly used by the timing controller and source driver.

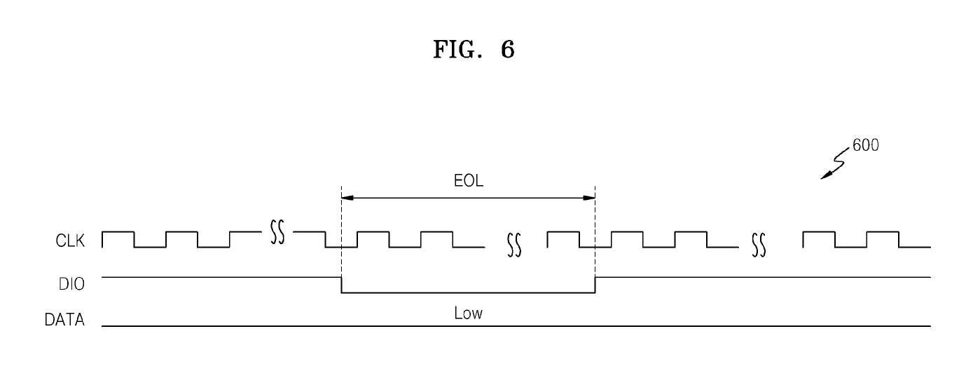

FIG. 6 is a waveform diagram of signals related to a data stream transfer end indication (EOL). Referring to FIG. 6, in the data stream transfer end indication (EOL), both data signal DATA and data input/output control signal DIO output from a timing controller are low.

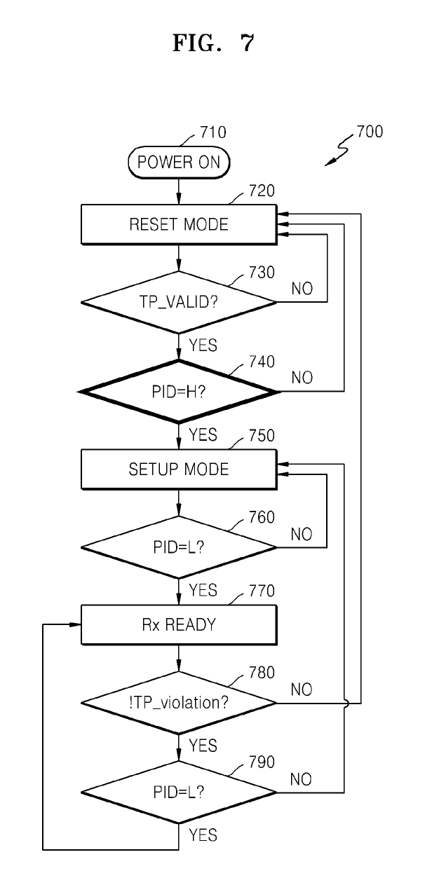

FIG. 7 is a flowchart summarizing an embodiment of the inventive concept providing a panel interface control method 700 for a data Tx/Rx system. Referring to FIG. 7, the panel interface method 700 comprises; entering a reset mode (720) following a power-up detection (710). Entry into a setup mode (750) is conditioned upon (a) a valid TP condition (730=yes) and (b) a proper PID value indicating entry into the setup mode (e.g., PID=H or 740=yes). Otherwise, the Tx/Rx system cycles in the reset mode (730=no, or 740=no).

In the reset mode (720), source driver register values are initialized. In the setup mode (750), certain source driver values may be updated in response to a control data provided in a current data stream received by the source driver from a timing controller.

Entry into the receive ready mode (770) from the setup mode (750) is conditioned on transition of the PID value to indicate entry into the receive ready mode (e.g., PID=L or 760=yes). Otherwise, the Tx/Rx system cycles in the setup mode (760=no). In the receive ready mode (770), the source driver either prepares to receive the current data stream as communicated from the timing controller or actually receives the current data stream.

The Tx/Rx system then returns to the reset mode (720) from the receive ready mode (770) upon (a) detecting a TP violation (730=yes) or (b) a transition in the PID value from the value indicating the receive ready mode (e.g., PID=H or 790=no). Otherwise, the Tx/Rx system cycles in the receive ready mode (780=yes and 790=yes).

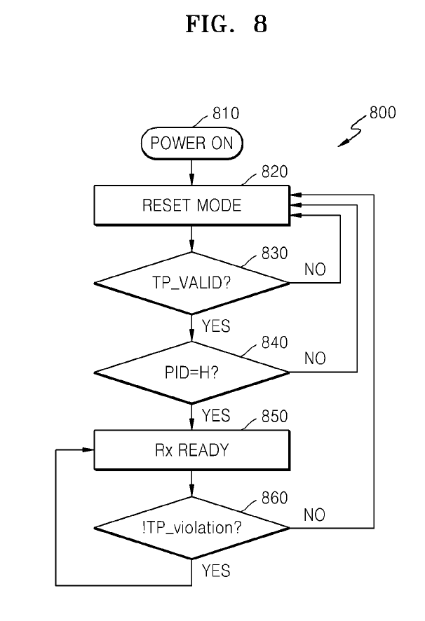

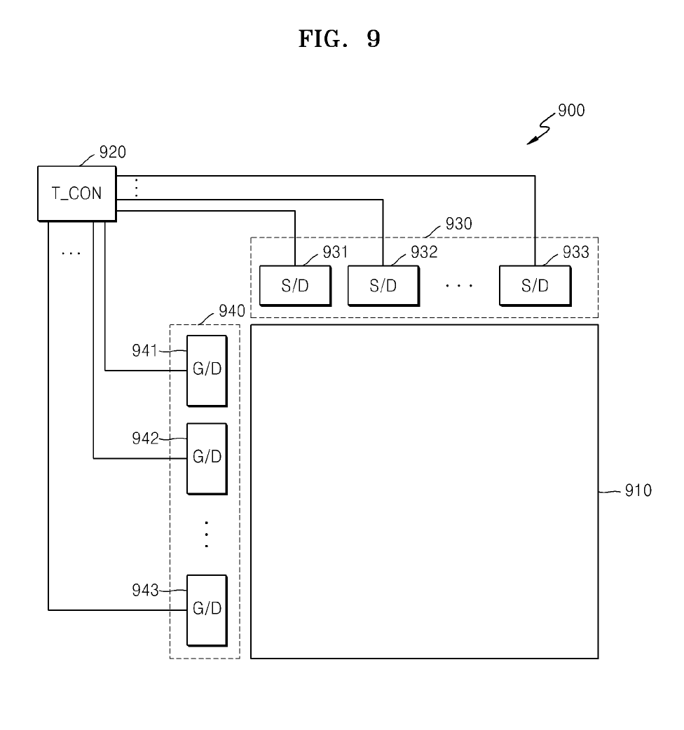

FIG. 8 is a flowchart summarizing another embodiment of the inventive concept providing a panel interface control method 800 for a data Tx/Rx system. Referring to FIG. 8, in the panel interface method 800, only a reset mode (820) and a receive ready mode (850) are possible, with no corresponding setup mode, as before.

Referring to FIG. 8, the panel interface method 800 comprises; entering a reset mode (820) following a power-up detection (810). Entry into a receive ready mode (850) is conditioned upon (a) a valid TP condition (830=yes) and (b) a proper PID value indicating entry into the receive ready mode (e.g., PID=H or 840=yes). Otherwise, the Tx/Rx system cycles in the reset mode (830=no, or 840=no).

In the receive ready mode (850), the source driver either prepares to receive the current data stream as communicated from the timing controller or actually receives the current data stream. The Tx/Rx system then returns to the reset mode (820) from the receive ready mode (850) upon detecting a TP violation (860=yes). Otherwise, the Tx/Rx system cycles in the receive ready mode (860=yes).

As noted above, a TP violation may be intentionally caused to drive the Tx/Rx system from the receive ready mode (850) into the reset mode (820). Also, although not illustrated in FIG. 8, source driver register values may be updated in the receive ready mode (850), as needed.

It should be noted again at this point that the timing controller of a panel display has been described as one example of a transmitter communicating payload data (i.e., display data) in a data stream to a source driver, as an example of a receiver. However, as will be later described, at least one source driver integrated circuit may be a receiver and a data stream may be transmitted to or received therefrom.

FIG. 9 is a block diagram of a liquid crystal display (LCD) apparatus 900 employing a point to point data communication method according to an embodiment of the inventive concept. Referring to FIG. 9, the LCD apparatus 900 comprises a display panel 910, a timing controller 920, a source driver block 930, and a gate driver block 940. The timing controller 920 controls the source driver block 930 and the gate driver block 940 by using a point to point method. Source driver integrated circuits 931 through 933 of the source driver block 930 and gate driver integrated circuits 941 through 943 of the gate driver block 940 control the display panel 910.

While the present inventive concept has been particularly shown and described with reference to exemplary embodiments thereof, it will be understood by those of ordinary skill in the art that various changes in form and details may be made therein without departing from the scope of the inventive concept as defined by the following claims.

What is claimed is:

1. An interface method for a data transmitting and receiving system comprising a transmitter and a receiver, the method comprising:
resetting the receiver in response to a data stream communicated from the transmitter or upon detecting power-up of the transmitter or receiver; and
operating the receiver in response to a current data stream received from the transmitter, wherein the operating of the receiver comprises at least one of; (a) updating data stored in the receiver according to control data contained in the current data stream, and (b) receiving payload data contained in the current data stream.

2. The method of claim 1, wherein the control data comprises at least one of; (a) data causing reset of the receiver, (b) data causing update of the data stored in the receiver, and (c) data causing receipt and processing of the payload data.

3. The method of claim 1, wherein the data stream is communicated from the transmitter to the receiver using a point to point data communication method.

4. An interface method for a data transmitting and receiving system comprising a timing controller and a source driver driving display data to a panel display, the method comprising:
operating in a reset mode during which a value stored in a register of the source driver is initialized in response to (a) an indication that the timing controller is communicating a current data stream, and (b) a power-up detection for the source driver or the timing controller; and
operating in a receive ready mode during which the source driver prepares to receive payload data contained in the current data stream.

5. The method of claim 4, further comprising:
operating in a setup mode during which control data contained in the current data stream updates data stored in a register of the source driver.

6. The method of claim 4, wherein operation in the reset mode is entered when a data stream transfer end indication is not provided between two consecutive data stream transfer start indications.

7. The method of claim 5, wherein operation in the setup mode is entered from the reset set or the receive ready state when packet identity data (PID) contained in the control data indicates entry into the setup mode.

8. The method of claim 7, wherein operation in the setup mode is entered when a data stream transfer end indication is not provided between two consecutive data stream transfer start indications.

9. The method of claim 4, wherein operation in the receive ready mode comprises at least one frame period during which payload data contained in the current data stream is received by the source driver.

10. The method of claim 4, wherein operation in the receive ready mode is entered when the packet identity data (PID) contained in control data in the current data stream indicates entry into the receive ready mode.

11. The method of claim 5, further comprising operating in a built in self test mode before initially operating in the reset mode.

12. The method of claim 5, wherein operation in the receive ready mode comprises a plurality of frame periods during which payload data segments contained in respective data streams is received by the source driver, the method further comprising:
operating in the setup mode between successive ones of the plurality of frame periods.

13. The method of claim 4, wherein the current data stream is communicated to the source driver from the timing controller using a point to point data communication method.

14. An interface method for a data transmitting and receiving system comprising a timing controller and a source driver driving display data to a panel display, the method comprising:
operating in a reset mode during which a value stored in a register of the source driver is initialized in response to a current data stream communicated from the timing controller to the source driver, or in response to a power-up detection for the source driver or to the timing controller;
operating in a setup mode during which control data contained in the current data stream initializes a value stored in the register of the source driver; and
operating in a receive ready mode during which the source driver prepares to receive the display data contained in the current data stream,
wherein the data stream also contains:
a data stream transfer start indication indicating a beginning of a transfer of the current data stream from the timing controller to the source driver;
register control data configured to update the value stored in the register of the source driver;
data defining a wait period during which the display data is processed by the source driver;
a data stream transfer end indication indicating an ending of a transfer of the current data stream from the timing controller to the source driver; and
data defining a standby period prior to receipt of a next data stream.

15. The method of claim 14, wherein the data stream transfer start indication is determined in response to a data input/output control signal and a data signal provided by the timing controller, and in response to configuration data contained in the current data stream, such that the data stream transfer start indication extends from a transition of the data signal from low to high during a time period in which the data input/output control signal is high to a detection of the configuration data during a tie period in which the data input/output control signal is low while the data signal is high.

16. The method of claim 14, wherein, in the data stream transfer end indication is determined in response to both a data signal and a data input/output control signal provided by the timing controller being low.

17. The method of claim 14, wherein the data stream is communicated from the timing controller to the source driver using a point to point data communication method.
